(19) United States
(12) Patent Application Publication
(10) Pub. No.: US 2023/0051118 A1
(43) Pub. Date: Feb. 16, 2023

(54) HARD COATING FILM AND IMAGE DISPLAY DEVICE INCLUDING THE SAME

(71) Applicant: Dongwoo Fine-Chem Co., Ltd., Iksan-si (KR)

(72) Inventors: Seung-Hee KIM, Yongin-si (KR); Hye-Lin KIM, Busan (KR); Min-Kyung KANG, Hwaseong-si (KR); Geo-San LIM, Seoul (KR)

(21) Appl. No.: 17/399,526

(22) Filed: Aug. 11, 2021

(51) Int. Cl. C09D 4/00; C09D 7/40; C09D 7/61; C09D 135/02; C09D 133/06; G02B 1/14

(52) U.S. Cl. CPC C09D 4/00; C09D 7/67; C09D 7/61; C09D 135/02; C09D 133/062; G02B 1/14

(57) ABSTRACT

The present disclosure relates to a hard coating film capable of providing excellent durability, elastic recovery rate, and abrasion resistance, by including a base layer; a first hard coating layer formed on at least one surface of the base layer and including a fluorine-based UV-curable functional group-containing compound; and a second hard coating layer formed between the base layer and the first hard coating layer and including inorganic particles; and an image display device including the hard coating film.

### TECHNICAL FIELD

The present disclosure relates to a hard coating film and an image display device including the same.

### BACKGROUND ART

Recently, an image display device such as a liquid crystal display (LCD) device or an organic light emitting display (OLED) device has continuously become thin and flexible. Accordingly, the image display device has been widely applied to various smart devices having portability, including various wearable devices as well as smartphones and tablet personal computers (PCs).

A window film or a protective film made of a tempered glass material may be formed on or in a display panel to protect the image display device from external environments such as scratches, drop impact, external moisture, oil, etc. However, the window film is disadvantageous in reducing the weight of the display panel or the image display device due to the properties of the tempered glass, and is easily broken by external impact. In addition, there is a limit to implementing the flexible properties through a bendable or foldable function.

Recently, a study on an optical plastic cover that can secure flexibility and impact resistance and can replace the window film made of the tempered glass material thus has been conducted.

However, the optical plastic cover has lower hardness and scratch resistance than the window film made of the tempered glass material, and accordingly, the image display device or the display panel may have reduced impact resistance against external impact.

Recently, a flexible display capable of still maintaining display performance as it is even though bent like paper using a material having flexibility, such as plastic instead of an existing glass substrate that does not have flexibility, has also rapidly attracted attention as the next-generation display device. Accordingly, it is necessary to develop a hard coating film having high hardness, good scratch resistance, and also excellent flexibility.

In this regard, Korean Patent Laid-Open Publication No. 10-2007-0087003 discloses an antireflective hard coating film containing a reactive silicone, where a hard coating layer and an antireflective layer are sequentially stacked on at least one surface of the transparent plastic film substrate, and the hard coating layer has a curable compound having a (meth)acrylate group and a (meth)acrylate group in a specific content range.

Also, Korean Patent Laid-Open Publication No. 10-2019-0038590 discloses a hard coating film, where the hard coating layer is stacked on at least one main surface of a base film, a difference in refractive index between the base film and the hard coating layer is less than or equal to a specific value, and the hard coating layer has a specific thickness range.

However, the patents described above have a limitation in forming a hard coating film having improved durability, elastic recovery rate, and abrasion resistance.

### RELATED ART DOCUMENT

### Patent Document

(Patent Document 1) Korean Patent Laid-Open Publication No. 10-2007-0087003
(Patent Document 1) Korean Patent Laid-Open Publication No. 10-2019-0038590

### DISCLOSURE

### Technical Problem

An object of the present disclosure is to provide a hard coating film having excellent durability, elastic recovery rate, and abrasion resistance.

Another object of the present disclosure is to provide an image display device including the hard coating film.

### Technical Solution

In an aspect, there is provided a hard coating film including: a base layer; a first hard coating layer formed on at least one surface of the base layer and including a fluorine-based UV-curable functional group-containing compound; and a second hard coating layer formed between the base layer and the first hard coating layer and including inorganic particles.

In another aspect, there is provided an image display device including the hard coating film described above.

### Advantageous Effects

The hard coating film according to the present disclosure exhibits further improved antifouling performance to represent excellent abrasion resistance properties, and has an excellent elastic recovery rate and thus, has excellent pen-pressing properties. In addition, the hard coating film according to the present disclosure may secure durability such as scratch resistance, chemical resistance, and bending resistance. Thus, the image display device including the hard coating film according to the present disclosure may provide improved mechanical reliability and flexibility.

### DESCRIPTION OF DRAWINGS

FIG. 1 is a schematic cross-sectional view for describing a hard coating film according to an embodiment of the present disclosure.

### BEST MODEL

The present disclosure relates to a hard coating film capable of providing excellent durability, elastic recovery rate, and abrasion resistance, by including a base layer; a first hard coating layer formed on at least one surface of the base layer and including a fluorine-based UV-curable functional group-containing compound; and a second hard coating layer formed between the base layer and the first hard coating layer and including inorganic particles; and an image display device including the hard coating film.

For example, the hard coating film according to the present disclosure exhibits a water contact angle of 95 degrees (°) or more measured after rubbing a surface of the first hard coating layer 3000 times under a load of a weight of 500 g with an abrasion-resistant eraser, and may thus provide excellent abrasion resistance. In addition, the hard coating film according to the present disclosure exhibits a water contact angle of 95 degrees (°) or more measured after rubbing a surface of the first hard coating layer at a site where ethanol was dropped 3000 times under a load of a weight of 500 g with an abrasion-resistant eraser, and may thus represent excellent properties in terms of durability such as chemical resistance. Furthermore, the hard coating film according to the present disclosure has an excellent elastic recovery rate, with an elastic recovery rate of 56% or more, as measured under a load of 5 mN. In addition, when the surface of the first hard coating layer is pressed with an electronic pen, the occurrence of pressing visibility may be prevented, such that the hard coating film may represent improved properties in terms of pen-pressing properties.

Hereinafter, the present disclosure will be described in detail.

<Hard Coating Film>

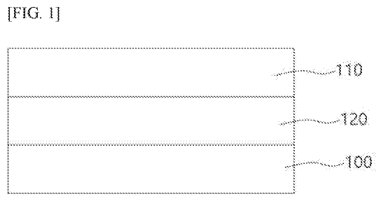

FIG. 1 is a schematic cross-sectional view for describing a hard coating film according to an embodiment of the present disclosure.

Referring to FIG. 1, the hard coating film includes a base layer 100, a first hard coating layer 110 and a second hard coating layer 120, and includes a structure in which the base layer 100, the second hard coating layer 120, and the first hard coating layer 110 are sequentially stacked.

The hard coating film according to the present disclosure exhibits further improved antifouling performance to represent excellent abrasion resistance properties, has excellent pen-pressing properties due to its excellent elastic recovery rate, and is excellent in terms of durability such as scratch resistance, chemical resistance, and bending resistance.

In addition, as the hard coating film according to the present disclosure is stacked in the order of the base layer 100, the second hard coating layer 120, and the first hard coating layer 110, mixing of the components used in the formation of the first hard coating layer and the components constituting the base layer may be prevented, so that the abrasion resistance in the first hard coating layer may be further improved.

Base Layer

The base layer 100 is for supporting the first hard coating layer and the second hard coating layer to be described later, and the hard coating layers formed on the base layer 100 are formed by sequentially stacking the second hard coating layer and the first hard coating layer by applying and curing the hard coating composition on at least one surface of the base layer.

In the present disclosure, the base layer 100 is a transparent film, and any transparent film may be used as long as it is a transparent polymer film.

For example, the base layer 100 may be a film formed of a polymer such as triacetyl cellulose, acetyl cellulose butyrate, ethylene-vinyl acetate copolymer, propionyl cellulose, butyryl cellulose, acetyl propionyl cellulose, polyester, polystyrene, polyamide, polyetherimide, polyacryl, polyimide, polyethersulfone, polysulfone, polyethylene, polypropylene, polymethylpentene, polyvinyl chloride, polyvinylidene chloride, polyvinyl alcohol, polyvinyl acetal, polyether ketone, polyetheretherketone, polyethersulfone, polymethyl methacrylate, polybutylene terephthalate, polyethylene naphthalate, polycarbonate. These polymers may be used alone or in combination of two or more.

First Hard Coating Layer

The first hard coating layer 110 is formed on at least one surface of the base layer 100, and more specifically, is formed on the second hard coating layer 120 stacked on the base layer 100.

For example, the first hard coating layer 110 may be formed by applying the first hard coating composition containing a fluorine-based UV-curable functional group-containing compound, a light-transmitting resin, a solvent, and a photoinitiator on the second hard coating layer 120 and then photocuring the second hard coating layer 120 by irradiation with ultraviolet rays.

The fluorine-based UV-curable functional group-containing compound is a component that imparts antifouling properties, abrasion resistance, and chemical resistance, and need to contain a fluorine component, and has a UV-curable functional group. Thus, it is not particularly limited as long as it can be chemically bonded to a monomer or oligomer layer forming the hard coating layer.

In the present disclosure, the first hard coating layer 110 may include a fluorine-based UV-curable functional group-containing compound to exhibit more improved abrasion resistance properties.

For example, as used herein, the UV-curable functional group may refer to a fluorine-containing aliphatic hydrocarbon group or a fluorine-containing aromatic hydrocarbon group.

Specifically, examples of the fluorine-based UV-curable functional group-containing compound may include a compound containing one or more fluoro groups, (meth)acrylate containing one or more fluoro groups, etc. Preferably, examples of the fluorine-based UV-curable functional group-containing compound may include (meth)acrylate containing a perfluoro aliphatic group. (meth)acrylate containing a perfluoro aromatic group, etc. In this case, it is more desirable for the fluorine-based UV-curable functional group-containing compound to have 1 to 6 UV-curable functional groups.

Examples of the fluorine-based UV-curable functional group-containing compound may include 2,2,2-trifluoroethyl acrylate, 2,2,3,3,3-pentafluoropropyl acrylate, 2-perfluorobutylethyl acrylate, 3-perfluorobutyl-2-hydroxypropyl acrylate, 2-perfluorohexylethyl acrylate, 3-perfluorohexyl-2-hydroxypropyl acrylate, 2-perfluorooctylethyl acrylate, 3-perfluorooctyl-2-hydroxypropyl acrylate, 2-perfluorodecylethyl acrylate, 2-perfluoro-3-methylbutylethyl acrylate, 3-perfluoro-3-methoxybutyl-2-hydroxypropyl acrylate, 2-perfluoro-5-methylhexylethyl acrylate, 3-perfluoro-5-methylhexyl-2-hydroxypropyl acrylate, 2-perfluoro-7-methyloctyl-2-hydroxypropyl acrylate, tetrafluoropropyl acrylate, octafluoropentyl acrylate, dodecafluoroheptyl acrylate, hexadecafluorononyl acrylate, hexafluorobutyl acrylate, 2,2,2-trifluoroethyl methacrylate, 2,2,3,3,3-pentafluoropropyl methacrylate, 2-perfluorobutylethyl methacrylate, 3-perfluorobutyl-2-hydroxypropyl methacrylate, 2-perfluorooctylethyl methacrylate, 3-perfluorooctyl-2-hydroxypropyl methacrylate, 2-perfluorodecylethyl methacrylate, 2-perfluoro-3-methylbutylethyl methacrylate, 3-perfluoro-3-methylbutyl-2-hydroxypropyl methacrylate, 2-perfluoro-5-methylhexylethyl methacrylate, 3-perfluoro-5-methylhexyl-2-hydroxypropyl methacrylate, 2-perfluoro-7-methyloctylethyl methacrylate, 3-perfluoro-6-methyloctyl methacrylate, tetrafluoropropyl methacrylate, octafluoropentyl methacrylate, octafluoropentyl methacrylate, dodecafluoroheptyl methacrylate, hexadecafluorononyl methacrylate, 1-trifluoromethyltrifluoroethyl methacrylate, hexafluorobutyl methacrylate, triacryloyl-heptadecafluorononenyl-pentaerythritol, etc.

Examples of commercially available products of the fluorine-based UV-curable functional group-containing compound that may be used in the present disclosure may include KY-1203 (Shin-Etsu Silicone), OPTOOL DAC-HP (Daikin Industries, Ltd.), UVAS-2003 (Sooyangchem Corp.), etc., and these products may be used in the preparation of the first hard coating composition of the present invention.

In an embodiment of the present disclosure, it is preferred that the fluorine-based UV-curable functional group-containing compound is contained in an amount of greater than 0.01 to 10 parts by weight, based on 100 parts by weight of the total first hard coating composition. If the fluorine-based UV-curable functional group-containing compound is contained in an amount of 0.01 parts by weight or less in the first hard coating composition, it is difficult to sufficiently achieve abrasion resistance and antifouling properties, and if the fluorine-based UV-curable functional group-containing compound is contained in an amount exceeding 10 parts by weight in the first hard coating composition, film hardness and scratch resistance may deteriorate.

The light-transmitting resin is a photocurable resin, and the photocurable resin may include a photocurable (meth)acrylate oligomer or monomer.

The photocurable (meth)acrylate oligomer, epoxy (meth)acrylate, urethane (meth)acrylate, etc., are commonly used, and urethane (meth)acrylate is more preferable. Urethane (meth)acrylate may prepare a compound having a polyfunctional (meth)acrylate and an isocyanate group having a hydroxyl group in the molecule, in the presence of a catalyst. Specific examples of the (meth)acrylate having a hydroxyl group in the molecule may be one or more selected from the group consisting of 2-hydroxyethyl (meth)acrylate, 2-hydroxyisopropyl (meth)acrylate, 4-hydroxybutyl (meth)acrylate, caprolactone ring-opened hydroxyacrylate, a pentaerythritol tri/tetra (meth)acrylate mixture, and a dipentaerythritol penta/hexa (meth)acrylate mixture.

In addition, specific examples of the compound having the isocyanate group may be one or more selected from the group consisting of 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexene diisocyanate, 4,4′-methylenebis(cyclohexylisocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis(2,6-dimethylphenylisocyanate), 4,4′-oxybis(phenylisocyanate), trifunctional isocyanate derived from hexamethylene diisocyanate, and trimethanpropanol adduct toluene diisocyanate.

The monomer is a commonly used and has an unsaturated group such as a (meth)acryloyl group, a vinyl group, a styryl group, and an allyl group in the molecule, as a photocurable functional group. Among these, a (meth)acryloyl group is more preferable.

Specific examples of the monomer having the (meth)acryloyl group may be one or more selected from the group consisting of neopentyl glycol acrylate, 1,6-hexanediol (meth)acrylate, propylene glycol di(meth)acrylate, triethylene glycol di(meth)acrylate, dipropylene glycol di(meth)acrylate, polyethylene glycol di(meth)acrylate, polypropylene glycol di(meth)acrylate, trimethylolpropane tri(meth)acrylate, trimethylolethane tri(meth)acrylate, 1,2,4-cyclohexanetetra (meth)acrylate, pentaglycerol tri(meth)acrylate, pentaerythritol tetra(meth)acrylate, pentaerythritol tri(meth)acrylate, dipentaerythritol tri(meth)acrylate, dipentaerythritol penta(meth)acrylate, dipentaerythritol tetra(meth)acrylate, dipentaerythritol hexa(meth)acrylate, tripentaerythritol tri(meth)acrylate, tripentaerythritol hexatri(meth)acrylate, bis(2-hydroxyethyl) isocyanurate di(meth)acrylate, hydroxyethyl (meth)acrylate, hydroxypropyl (meth)acrylate, hydroxybutyl (meth)acrylate, isooctyl (meth)acrylate, iso-dexyl (meth)acrylate, stearyl (meth)acrylate, tetrahydrofurfuryl (meth)acrylate, phenoxyethyl (meth)acrylate, and isobomeol (meth)acrylate.

The photocurable (meth)acrylate oligomer or monomer, which is the light-transmitting resin exemplified above, may be used alone or in combination of two or more.

The light-transmitting resin is not particularly limited, but it is desirable to be contained in an amount of 1 to 80 parts by weight based on 100 parts by weight of the total first hard coating composition. If the light-transmitting resin is contained in an amount of less than 1 part by weight, it is difficult to achieve sufficient hardness improvement, and if the light-transmitting resin is contained in an amount exceeding 80 parts by weight, curling may become severe.

The same description of the light-transmitting resin may also be applied to the second hard coating composition.

In the present disclosure, each of the light-transmitting resins contained in the first hard coating composition and the second hard coating composition, may be the same as or different from each other.

The solvent may dissolve or disperse the above-mentioned composition, and may be used without limitation as long as it is known as a solvent for a composition for forming a coating layer in the art.

Examples of the available solvent may include preferably alcohols, such as methanol, ethanol, isopropanol, butanol, methyl cellosolve and ethyl cellosolve; ketones such as methyl ethyl ketone, methyl butyl ketone, methyl isobutyl ketone, diethyl ketone, dipropyl ketone, and cyclohexanone; acetates, such as ethyl acetate, propyl acetate, n-butyl acetate, t-butyl acetate, methyl cellosolve acetate, ethyl cellosolve acetate, propylene glycol monomethyl ether acetate, propylene glycol monoethyl ether acetate, propylene glycol monopropyl ether acetate, methoxybutyl acetate, and methoxypentyl acetate; hexanes, such as hexane, heptane, and octane; benzenes, such as benzene, toluene, and xylene; ethers, such as diethylene glycol dimethyl ether, diethylene glycol diethyl ether, diethylene glycol dipropyl ether, diethylene glycol dibutyl ether, and propylene glycol monomethyl ether. Each of the solvents exemplified above may be used alone or in combination of two or more.

If the transparent film used as the base layer is a polyimide film, examples of good solvents therefor may include acetone, methyl ethyl ketone, cyclopentanone, ethyl acetate, etc. If the transparent film is a polyimide film, examples of the poor solvent therefor may include alcohols such as isopropyl alcohol, butanol and ethanol, and ethers such as butyl acetate and propylene glycol methyl ether.

Preferably, a good solvent alone or a mixed solvent in which a good solvent and a poor solvent are mixed is used as the solvent. The good solvent and the poor solvent may be appropriately selected according to the material of the transparent film used as the base layer.

These solvents are used in an amount of 10 to 95% by weight based on 100% by weight of the total first hard coating composition. If the content of the solvent is less than the above range, workability deteriorates due to high viscosity, and the swelling of the transparent film used as the base layer cannot be sufficiently progressed, and thus adhesion may be impaired. Conversely, if the content of the solvent exceeds the above range, a lot of drying time may be required, economical efficiency may deteriorate, and haze may occur due to severe swelling of the transparent base film. Therefore, a solvent is appropriately used within the above range.

The same description of the solvent may also be applied to the second hard coating composition to be described later.

In the present disclosure, each of the solvents contained in the first hard coating composition and the second hard coating composition may be the same as or different from each other.

The photoinitiator may be used without limitation as long as it is used in the art. The photoinitiator may be, for example, one or more selected from the group consisting of hydroxy ketones, amino ketones, hydrogen abstraction-type photoinitiators, and combinations thereof.

Specific examples of the photoinitiator may be one or more selected from the group consisting of 2-methyl-1-[4-(methylthio)phenyl]2-morpholinepropanone-1, diphenyl ketone, benzyl dimethyl ketal, 2-hydroxy-2-methyl-1-phenyl-1-one, 4-hydroxycyclophenyl ketone, 2,2-dimethoxy-2-phenyl-acetophenone, anthraquinone, fluorene, triphenylamine, carbazole, 3-methylacetophenone, 4-chloroacetophenone, 4,4-dimethoxyacetophenone, 4,4-diaminobenzophenone, 1-hydroxycyclohexylphenyl ketone, benzophenone, diphenyl (2,4,6-trimethylbenzoyl) phosphine oxide, and combinations thereof.

This photoinitiator may be used in an amount of 0.1 to 10% by weight, and preferably 1 to 5% by weight based on 100% by weight of the total first hard coating composition. In the present disclosure, if the content of the photoinitiator is less than the above range, the curing rate of the composition may be slow and non-curing may occur, resulting in poor mechanical properties. Conversely, if the content of the photoinitiator exceeds the above range, cracks may occur in the coating film due to overcuring.

The same description of the photoinitiator may also be applied to the second hard coating composition to be described later.

In the present disclosure, each of the photoinitiators contained in the first hard coating composition and the second hard coating composition may be the same as or different from each other.

Second Hard Coating Layer

The second hard coating layer may be formed between the base layer 100 and the first hard coating layer 110.

According to an embodiment of the present disclosure, the second hard coating layer 120 may be formed on at least one surface of the base layer 100. The second hard coating layer 120 may be formed from a second hard coating composition containing inorganic particles, a light-transmitting resin, a solvent, and a photoinitiator. If necessary, the second hard coating composition may further contain an additive.

The inorganic particles may be inorganic nanoparticles, and are components added to improve the elastic recovery rate of the hard coating layer.

Specifically, when the inorganic nanoparticles are contained in the second hard coating composition, mechanical properties may be further improved. More specifically, the inorganic nanoparticles may be uniformly formed in the coating film to improve mechanical properties such as pen-pressing and pencil hardness.

The inorganic nanoparticles may have an average particle diameter of 1 to 100 nm, specifically 1 to 80 nm, and more specifically 5 to 50 nm. If the average particle diameter of the inorganic nanoparticles is within the above range, it is possible to form a uniform coating film by preventing the occurrence of agglomeration in the composition. Also, it is possible to prevent the deterioration of the optical properties and mechanical properties of the coating film.

The inorganic nanoparticles may include, but is not limited to, one or more selected from the group consisting of Al₂O₃, SiO₂, ZnO, ZrO₂, BaTiO₃, TiO₂, Ta₂O₅, Ti₃O₅, ITO, IZO, ATO, ZnO—Al, Nb₂O₃, SnO, MgO, and combinations thereof, and may include a metal oxide generally used in the art.

Specifically, the inorganic nanoparticles may be Al₂O₃, SiO₂ and/or ZfO₂. The inorganic nanoparticles may be prepared directly or purchased commercially, and for commercially available products, one dispersed in an organic solvent at a concentration of 10 to 80% by weight may be used.

In an embodiment of the present disclosure, the second hard coating composition may further contain an additive, and the additive may include one or more selected from the group consisting of inorganic nanoparticles, a leveling agent, and a stabilizer.

Example of the leveling agent may include a silicone-based agent, an acrylic polymer-based agent, etc.

Since the description of the remaining components contained in the second hard coating composition, that is, the light-transmitting resin, the solvent, and the photoinitiator is the same as that described in the first hard coating composition described above, the description is omitted to avoid overlap.

The hard coating film according to the present disclosure has excellent properties in terms of durability, elastic recovery rate, abrasion resistance, etc., and may thus be usefully applied to a flexible display.

<Image Display Device>

Embodiments of the present invention provide an image display device including the hard coating film described above.

For example, it may be applied as a window or a window laminating agent including the hard coating film described above, and in this case, at least one of a polarizing layer and a touch sensor layer may be stacked on one surface of the window on which the hard coating film is formed. Such a window or a window laminate may be applied as a window film formed on the outermost surface of the image display device. In addition, the hard coating film may be inserted, for example, inside the image display device.

The image display device, for example, includes various image display devices, such as a liquid crystal display device, an electroluminescence display device, a plasma display device, and a field emission display device, and may be a flexible display device having flexibility and bending properties.

In this case, the hard coating laminate according to embodiments of the present disclosure may be more effectively applied as the window or window laminate of the flexible display device. The interaction between the first hard coating layer 110 and the second hard coating layer 120 included in the hard coating laminate according to embodiments of the present disclosure, may improve both flexibility and durability of the window, and may also implement antistatic performance. Thus, for example, impact resistance and abrasion resistance of the flexible display device may be improved, and damage such as cracks and peeling may be prevented even during bending.

Hereinafter, experimental examples including specific examples and comparative examples are presented to assist the understanding of the present disclosure. However, it will be obvious to those skilled in the art that the following examples are merely illustrative of the present disclosure and are not intended to limit the appended claims, and various modifications and alterations to the embodiments may be made without departing from the scope and spirit of the present disclosure. In addition, these modifications and alterations will fall within the appended claims. In addition, “%” and “part” indicating the content below are based on weight unless otherwise specified.

### PREPARATION EXAMPLES

### Preparation Example 1: Preparation of Hard Coating Composition (A-1)

23 parts by weight of hexafunctional urethane acrylate (Gongyoungsa, Co., Ltd., UA-3061), 23 parts by weight of acrylate (Miwon Specialty Chemical Co., Ltd., Miramer SP1106), 50 parts by weight of methyl ethyl ketone, 3.5 parts by weight of 1-hydroxycyclohexylphenyl ketone, 0.5 parts by weight of a fluorine-based UV-curable functional group-containing compound (Shin-Etsu Silicone, KY-1203) were blended using a stirrer and filtered using a PP filter to prepare a hard coating composition.

### Preparation Example 2: Preparation of Hard Coating Composition (A-2)

23 parts by weight of hexafunctional urethane acrylate (DKS, Co., Ltd., MF-101), 23 parts by weight of acrylate (Osaka Organic Chemical Industry Ltd., VISCOAT 1000), 50 parts by weight of methyl ethyl ketone, 3.5 parts by weight of 1-hydroxycyclohexylphenyl ketone, 0.5 parts by weight of a fluorine-based UV-curable functional group-containing compound (Daikin Industries, Ltd., OPTOOL DAC-HP) were blended using a stirrer and filtered using a PP filter to prepare a hard coating composition.

### Preparation Example 3: Preparation of Hard Coating Composition (A-3)

23 parts by weight of hexafunctional urethane acrylate (Gongyoungsa, Co., Ltd., UA-3061), 23 parts by weight of acrylate (Miwon Specialty Chemical Co., Ltd., Miramer SP1106), 50 parts by weight of methyl ethyl ketone, 3.5 parts by weight of 1-hydroxycyclohexylphenyl ketone, 0.5 parts by weight of a fluorine-based UV-curable functional group-containing compound (Sooyangchem Crop., UVAS-2003) were blended using a stirrer and filtered using a PP filter to prepare a hard coating composition having abrasion resistance.

### Preparation Example 4: Preparation of Hard Coating Composition (A-4)

24.2 parts by weight of hexafunctional urethane acrylate (DKS, Co., Ltd., MF-101), 50 parts by weight of a silica particle dispersion compound (Nissan Chemical Industries, Ltd., PGM-AC-2140Y), 24.3 parts by weight of methyl ethyl ketone, 3.5 parts by weight of 1-hydroxy cyclohexylphenyl ketone, and 0.5 parts by weight of a silicone-based additive (BYK, BYK UV-3530) were blended using a stirrer and filtered using a PP filter to prepare a hard coating composition.

### Preparation Example 5: Preparation of Hard Coating Composition (A-5)

24.2 parts by weight acrylate (Osaka Organic Chemical Industry Ltd., VISCOAT 1000), 50 parts by weight of a silica particle dispersion compound (Nissan Chemical Industries, Ltd., PGM-AC-2140Y), 24.3 parts by weight of methyl ethyl ketone, 3.5 parts by weight of 1-hydroxy cyclohexylphenyl ketone, and 0.5 parts by weight of a silicone-based additive (BYK, BYK UV-3530) were blended using a stirrer and filtered using a PP filter to prepare a hard coating composition.

### Preparation Example 6: Preparation of Hard Coating Composition (A-6)

12.1 parts by weight of hexafunctional urethane acrylate (DKS, Co., Ltd., MF-101), 12.1 parts by weight of acrylate (Osaka Organic Chemical Industry Ltd., VISCOAT 1000), 50 parts by weight of a silica particle dispersion compound (Nissan Chemical Industries, Ltd., PGM-AC-2140Y), 24.3 parts by weight of methyl ethyl ketone, 1 part by weight of 1-hydroxy cyclohexylphenyl ketone, and 0.5 parts by weight of a fluorine-based UV-curable functional group-containing compound (Shin-Etsu Silicone, KY-1203) were blended using a stirrer and filtered using a PP filter to prepare a hard coating composition.

### Examples and Comparative Examples: Preparation of Hard Coating Film

### Example 1

After curing the hard coating composition (A-4) of Preparation Example 4 on a polyimide film (PI, 50 μm), the coating was made to have a thickness of 1 μm, the solvent was dried, and a UV accumulated light amount of 150 mJ/cm² was irradiated under nitrogen atmosphere to form a second hard coating layer. After curing the hard coating composition (A-1) of Preparation Example 1 on the second hard coating layer, the coating was made to have a thickness of 4 μm, the solvent was dried, and a UV accumulated light amount of 600 md/cm² was irradiated under nitrogen atmosphere to form a first hard coating layer.

### Example 2

After curing the hard coating composition (A-4) of Preparation Example 4 on a polyimide film (PI, 50 μm), the coating was made to have a thickness of 1 μm, the solvent was dried, and a UV accumulated light amount of 150 mJ/cm² was irradiated under nitrogen atmosphere to form a second hard coating layer. After curing the hard coating composition (A-2) of Preparation Example 2 on the second hard coating layer, the coating was made to have a thickness of 4 μm, the solvent was dried, and a UV accumulated light amount of 600 md/cm² was irradiated under nitrogen atmosphere to form a first hard coating layer.

### Example 3

After curing the hard coating composition (A-4) of Preparation Example 4 on a polyimide film (PI, 50 μm), the coating was made to have a thickness of 1 μm, the solvent was dried, and a UV accumulated light amount of 150 mJ/cm² was irradiated under nitrogen atmosphere to form a second hard coating layer. After curing the hard coating composition (A-3) of Preparation Example 3 on the second hard coating layer, the coating was made to have a thickness of 4 μm, the solvent was dried, and a UV accumulated light amount of 600 mJ/cm² was irradiated under nitrogen atmosphere to form a first hard coating layer.

### Example 4

After curing the hard coating composition (A-5) of Preparation Example 5 on a polyimide film (PI, 50 μm), the coating was made to have a thickness of 1 μm, the solvent was dried, and a UV accumulated light amount of 150 mJ/cm² was irradiated under nitrogen atmosphere to form a second hard coating layer. After curing the hard coating composition (A-1) of Preparation Example 1 on the second hard coating layer, the coating was made to have a thickness of 4 μm, the solvent was dried, and a UV accumulated light amount of 600 mJ/cm² was irradiated under nitrogen atmosphere to form a first hard coating layer.

### Example 5

After curing the hard coating composition (A-5) of Preparation Example 5 on a polyimide film (PI, 50 μm), the coating was made to have a thickness of 1 μm, the solvent was dried, and a UV accumulated light amount of 150 mJ/cm² was irradiated under nitrogen atmosphere to form a second hard coating layer. After curing the hard coating composition (A-2) of Preparation Example 2 on the second hard coating layer, the coating was made have a thickness of 4 μm, the solvent was dried, and a UV accumulated light amount of 600 mJ/cm² was irradiated under nitrogen atmosphere to form a first hard coating layer.

### Example 6

After curing the hard coating composition (A-5) of Preparation Example 5 on a polyimide film (PI, 50 μm), the coating was made to have a thickness of 1 μm, the solvent was dried, and a UV accumulated light amount of 150 mJ/cm² was irradiated under nitrogen atmosphere to form a second hard coating layer. After cuing the hard coating composition (A-3) of Preparation Example 3 on the second hard coating layer, the coating made to have a thickness of 4 μm, the solvent was dried, and a UV accumulated light amount of 600 mJ/cm² was irradiated under nitrogen atmosphere to form a first hard coating layer.

### Comparative Example 1

After curing the hard coating composition (A-1) of Preparation Example 1 on a polyimide film (PI, 50 μm), the coating was made to have a thickness of 5 μm, the solvent was dried, and a UV accumulated light amount of 600 mJ/cm² was irradiated under nitrogen atmosphere to form a hard coating layer.

### Comparative Example 2

After curing the hard coating composition (A-2) of Preparation Example 2 on a polyimide film (PI, 50 μm), the coating was made to have a thickness of 5 μm, the solvent was dried, and a UV accumulated light amount of 6(0) mJ/cm² was irradiated under nitrogen atmosphere to form a hard coating layer.

### Comparative Example 3

After curing the hard coating composition (A-3) of Preparation Example 3 on a polyimide film (PI, 50 μm), the coating was made to have a thickness of 5 μm, the solvent was dried, and a UV accumulated light amount of 600 mJ/cm² was irradiated under nitrogen atmosphere to form a hard coating layer.

### Comparative Example 4

After curing the hard coating composition (A-4) of Preparation Example 4 on a polyimide film (PI, 50 μm), the coating was made to have a thickness of 5 μm, the solvent was dried, and a UV accumulated light amount of 600 mJ/cm² was irradiated under nitrogen atmosphere to form a hard coating layer.

### Comparative Example 5

After curing the hard coating composition (A-5) of Preparation Example 5 on a polyimide film (PI, 50 μm), the coating was made to have a thickness of 1 μm, the solvent was dried, and a UV accumulated light amount of 150 mJ/cm² was irradiated under nitrogen atmosphere to form a second hard coating layer.

After curing the hard coating composition (A-4) of Preparation Example 1 on a polyimide film (PI, 50 μm), the coating was made to have a thickness of 4 μm, the solvent was dried, and a UV accumulated light amount of 600 mJ/cm² was irradiated under nitrogen atmosphere to form a hard coating layer.

### Comparative Example 6

After curing the hard coating composition (A-6) of Preparation Example 6 on a polyimide film (PI, 50 μm), the coating was made to have a thickness of 5 μm, the solvent was dried, and a UV accumulated light amount of 600 mi/cm² was irradiated under nitrogen atmosphere to form a hard coating layer.

### Experimental Example

The physical properties of the hard coating films prepared in Examples 1 to 6 and Comparative Examples 1 to 4 were measured in the following manner, and the measurement results are shown in Table 1.

(1) Transmittance

The transmittance of the coating film was measured using a hazemeter HM-150N from Murakami Corporation.

(2) Scratch Resistance

The base film was bonded to the glass using a transparent adhesive so that the hard coating surface was positioned upward, and then the scratch resistance was measured by performing reciprocating friction 10 times under a load of 500 g/cm² using steel wool (#0000).

<Evaluation Criteria>

A: no scratches are visible or scratches are visible as 10 or less when observed by transmitting and reflecting a measurement part through a three-wavelength lamp

B: scratches are visible as more than 10 and not more than 20 when observed by transmitting and reflecting a measurement part through a three-wavelength lamp

C: scratches are observed as more than 20 when observed by transmitting and reflecting a measurement part through a three-wavelength lamp

(3) Contact Angle

A water contact angle was measured using contact angle measuring instrument DSA100 from KRUSS GmbH. At room temperature, the amount of liquid drop was 3 μl. In the present application, it was determined that the antifouling properties were excellent when the contact angle is 105 degrees or more.

(4) Abrasion Resistance

Measurements were made through an abrasion resistance meter from Daesung Precision Co. Ltd. The water contact angle (°) was measured after the coating surface was rubbed 3000 times using an abrasion-resistant eraser for testing (a rubber stick from Minoan Inc., tensile strength: 11.91 kgf/cm², a sample shape: solid, strength: 81 (Durometer A type), a chemical structure: rubber) and 500 g of a weight. In this case, it was evaluated that the abrasion resistance was excellent when the water contact angle was 95 degrees (°) or more.

(5) Chemical Resistance

Measurements were made through an abrasion resistance meter by Daesung Precision Co. Ltd. The water contact angle was measured after the coating surface was rubbed at a site where ethanol was dripped 3000 times using an abrasion-resistant eraser for testing (a rubber stick from Minoan Inc., tensile strength: 11.91 kgf/cm², a sample shape: solid, strength: 81 (Durometer A type)) and 500 g of a weight. In this case, it was evaluated that the chemical resistance was excellent when the water contact angle was 95 degrees (°) or more.

(6) Bending Resistance

It was observed whether the film was broken by repeating a film folding and unfolding test 200,000 times with a radius of curvature of 1 mm so that the hard coating surface was folded inward.

<Evaluation Criteria>

O: No breakage

X: Film was broken

(7) Pencil Hardness

The base film was fixed to the glass so that the hard coating surface was positioned upward, and then the pencil hardness was measured under a load of 1 kg. The test was conducted 5 times in a length of 1 cm using a pencil with the same hardness, and the hardness that was OK 4 or more times was expressed as pencil hardness.

(8) PEN Pressing Properties

The base film was fixed to the glass so that the hard coating surface was positioned upward, and then pen pressing was measured using a pencil hardness meter under a load of 500 g. It was observed whether pressing was visible by performing a test 5 times in a length of 1 cm using a Galaxy note Pen stylus as an electronic pen

<Evaluation Criteria>

O: Pressing was invisible

X: Pressing was visible

(9) Elastic Recovery Rate

The base film was bonded to the glass using a transparent adhesive so that the hard coating surface was positioned upward, and then the elastic recovery rate of the hard coating layer was measured using a nanoindenter (Fischer) under a micro-load of 5 mN. In this case, it was evaluated as excellent when the elastic recovery rate was 56% or more.

TABLE 1

| | | | | | | | | Com. | Com. | Com. | Com. | Com. | Com. |
|---|---|---|---|---|---|---|---|---|---|---|---|---|---|
| | | Example | Example | Example | Example | Example | Example | Example | Example | Example | Example | Example | Example |
| | | 1 | 2 | 3 | 4 | 5 | 6 | 1 | 2 | 3 | 4 | 5 | 6 |
| Hard | (3) | Prep. | Prep. | Prep. | Prep. | Prep. | Prep. | Prep. | Prep. | Prep. | Prep. | Prep. | Prep. |
| coating | First | Example | Example | Example | Example | Example | Example | Example | Example | Example | Example | Example | Example |
| film | hard | 1 | 2 | 3 | 1 | 2 | 3 | 1 | 2 | 3 | 4 | 1 | 6 |
| laminate | coating | | | | | | | | | | | | |
| structure | layer | | | | | | | | | | | | |
| | (2) | Prep. | Prep. | Prep. | Prep. | Prep. | Prep. | — | — | — | — | Prep. | — |
| | Second | Example | Example | Example | Example | Example | Example | | | | | Example | |
| | hard | 4 | 4 | 4 | 5 | 5 | 5 | | | | | 5 | |
| | coating | | | | | | | | | | | | |
| | layer | | | | | | | | | | | | |
| | (1) | Trans- | Trans- | Trans- | Trans- | Trans- | Trans- | Trans- | Trans- | Trans- | Trans- | Trans- | Trans- |
| | Base | parent | parent | parent | parent | parent | parent | parent | parent | parent | parent | parent | parent |
| | layer | substrate | substrate | substrate | substrate | substrate | substrate | substrate | substrate | substrate | substrate | substrate | substrate |

| Transimittance | 88.9 | 89 | 88.7 | 88.9 | 88.7 | 89 | 89.9 | 89.6 | 89.7 | 88.7 | 88.9 | 88.9 |
|---|---|---|---|---|---|---|---|---|---|---|---|---|
| (%) | | | | | | | | | | | | |
| Scratch | A | A | A | A | A | A | A | A | A | A | A | A |
| resistance | | | | | | | | | | | | |
| Contact | 111 | 110 | 112 | 111 | 110 | 110 | 111 | 110 | 110 | 80 | 110 | 110 |
| angle (°) | | | | | | | | | | | | |
| Abrasion | 105 | 103 | 98 | 103 | 103 | 100 | 85 | 87 | 85 | 56 | 83 | 73 |
| resistance (°) | | | | | | | | | | | | |
| Chemical | 105 | 100 | 97 | 99 | 99 | 98 | 78 | 80 | 83 | 58 | 81 | 70 |
| resistance (°) | | | | | | | | | | | | |
| Bending | ◯ | ◯ | ◯ | ◯ | ◯ | ◯ | ◯ | ◯ | ◯ | ◯ | X | ◯ |
| resistance | | | | | | | | | | | | |
| Pencil | 3H | 3H | 3H | 3H | 3H | 3H | 3H | 3H | 3H | 3H | 3H | 3H |
| hardness | | | | | | | | | | | | |
| PEN pressing | ◯ | ◯ | ◯ | ◯ | ◯ | ◯ | X | X | X | ◯ | ◯ | ◯ |
| properties | | | | | | | | | | | | |
| Elastic | 62 | 63 | 62 | 61 | 62 | 62 | 54 | 54 | 55 | 61 | 58 | 60 |
| recovery | | | | | | | | | | | | |

rate (%)

In Table 1, the hard coating films according to Examples 1 to 6 and Comparative Examples 1 to 6 have a laminated structure in the order of (1)-(2)-(3). Referring to Table 1, the hard coating films according to Examples 1 to 6 exhibited not only excellent transmittance, but also excellent antifouling performance, resulting in excellent abrasion resistance properties compared to the comparative examples. In addition, as the hard coating film showed excellent results in terms of elastic recovery rate, excellent results were also obtained in pen pressing properties and in reliability of scratch resistance, chemical resistance, and bending resistance.

In comparison, it can be seen that the hard coating films according to Comparative Examples 1 to 6 were significantly lowered in abrasion resistance and chemical resistance compared to Examples of the present disclosure. In addition, it could be confirmed that the hard coating films according to Comparative Examples 1 to 6 exhibited lowered results compared to the Example of the present invention in bending resistance, elastic recovery rate, and/or pen pressing properties.

1. A hard coating film comprising:
a base layer;
a first hard coating layer formed on at least one surface of the base layer and including a fluorine-based UV-curable functional group-containing compound; and
a second hard coating layer formed between the base layer and the first hard coating layer and including inorganic particles.

2. The hard coating film of claim 1, wherein the fluorine-based UV-curable functional group-containing compound includes one or more selected from (meth)acrylate containing a perfluoroaliphatic group and (meth)acrylate containing a perfluoroaromatic group.

3. The hard coating film of claim 2, wherein the fluorine-based UV-curable functional group-containing compound includes 1 to 6 UV-curable functional groups.

4. The hard coating film of claim 1, wherein the inorganic nanoparticles includes any one selected from the group consisting of Al₂O₃, SiO₂, ZnO, ZrO₂, BaTiO₃, TiO₂, Ta₂O₅, TiO₅, ITO, IZO, ATO, ZnO—Al, Nb₂O₃, SnO, MgO, and combinations thereof.

5. The hard coating film of claim 1, wherein the first hard coating layer is formed from a first hard coating composition containing a fluorine-based UV-curable functional group-containing compound, a light-transmitting resin, a solvent, and a photoinitiator.

6. The hard coating film of claim 1, wherein the second hard coating layer is formed from a second hard coating composition containing the inorganic particles, a light-transmitting resin, a solvent, and a photoinitiator.

7. The hard coating film of claim 1, wherein the hard coating film is applied to a flexible display.

8. The hard coating film of claim 1, wherein a water contact angle measured after rubbing a surface of the first hard coating layer 3,000 times under a load of a weight of 500 g with an abrasion-resistant eraser is 95 degrees or more.

9. The hard coating film of claim 1, wherein a water contact angle measured after rubbing a surface of the first hard coating layer at a site where ethanol was dropped 3000 times under a load of a weight of 500 g with an abrasion-resistant eraser is 95 degrees or more.

10. The hard coating film of claim 1, wherein an elastic recovery rate measured under a load of 5 mN is 56% or more.

11. The hard coating film of claim 1, wherein the occurrence of pressing visibility is prevented when a surface of the first hard coating layer is pressed with an electronic pen.

12. An image display device comprising the hard coating film of claim 1.
